(19) United States
(12) Patent Application Publication
(10) Pub. No.: US 2026/0148448 A1
(43) Pub. Date: May 28, 2026

(54) Text-Driven Image Editing via Image-Specific Finetuning of Diffusion Models

(71) Applicant: Google LLC, Mountain View, CA (US)

(72) Inventors: Yaniv Leviathan, Sunnyvale, CA (US); Daniel Walevski, Tel Aviv (IL); Matan Kalman, Sunnyvale, CA (US); Yossi Matias, Tel Aviv (IL)

(21) Appl. No.: 19/122,191

(22) PCT Filed: Oct. 17, 2023
(86) PCT No.: PCT/US2023/077117

§ 371 Date: Apr. 17, 2025

Related U.S. Application Data
(60) Provisional application No. 63/416,838, filed on Oct. 17, 2022.

(51) Int. Cl. G06T 11/60; G06N 20/00

(52) U.S. Cl. CPC G06T 11/60; G06N 20/00

(57) ABSTRACT

Provided are systems and methods for general text-driven image editing, example implementations of which may be referred to as “UniTune”. UniTune can receive as input an arbitrary image and a textual edit description, and can carry out the edit while maintaining high semantic and visual fidelity to the input image. UniTune does not require any additional inputs, like masks or sketches. According to an aspect of the present disclosure, with the right choice of parameters, example systems described herein can fine-tune a large diffusion model (e.g., Imagen) on a single image, encouraging the model to maintain fidelity to the input image, both visually and semantically, while still allowing expressive manipulations.

### RELATED APPLICATIONS

This application claims priority to and the benefit of U.S. Provisional Patent Application No. 63/416,838, filed Oct. 17, 2022. U.S. Provisional Patent Application No. 63/416,838 is hereby incorporated by reference in its entirety.

### FIELD

The present disclosure relates generally to machine learning. More particularly, the present disclosure relates to text-driven image editing via image-specific finetuning of diffusion models.

### BACKGROUND

High fidelity image manipulation via text commands is a long standing problem in computer graphics research. Using free-form commands to describe a desired edit, like “men wearing tuxedos”, “pixelart”, or “a blue house” is significantly easier than carrying out the changes manually in an image editing software. Language-based interfaces have the potential to make experts more efficient and to unlock graphic design capabilities for casual users. Despite amazing advancements in image generation methods, general domain high-fidelity image editing is still an unsolved problem.

In particular, revolutionary text-to-image models like Dall-E, Imagen, and StableDiffusion excel at creating images from scratch, or at filling manually-removed parts of existing images in a context-aware fashion. However, for editing operations, these models usually require the user to specify masks and often struggle with edits that depend on the masked portion of the image.

### SUMMARY

Aspects and advantages of embodiments of the present disclosure will be set forth in part in the following description, or can be learned from the description, or can be learned through practice of the embodiments.

One general aspect includes a computer-implemented method to perform text-driven image editing. The computer-implemented method includes obtaining, by a computing system may include one or more computing devices, a base image and an edit prompt, where the edit prompt may include or is derived from a natural language description of a desired edit to the base image. The method also includes accessing, by the computing system, a machine-learned diffusion model, where the machine-learned diffusion model has been finetuned on one or more finetuning tuples, each finetuning tuple may include the base image and a finetuning prompt. The method also includes processing, by the computing system, the finetuning prompt and the edit prompt with the machine-learned diffusion model to generate an output image. The method also includes providing, by the computing system, the output image as an output. Other embodiments of this aspect include corresponding computer systems, apparatus, and computer programs recorded on one or more computer storage devices, each configured to perform the actions of the methods.

Implementations may include one or more of the following features. The computer-implemented method described above, where the finetuning prompt may include or is derived from one or more rare tokens. The finetuning prompt may include or is derived from a base prompt that may include a natural language description of the base image. Processing, by the computing system, the finetuning prompt and the edit prompt with the machine-learned diffusion model may include: concatenating, by the computing system, the finetuning prompt with the edit prompt to generate a combined prompt; and processing, by the computing system, the combined prompt with the machine-learned diffusion model. Accessing, by the computing system, the machine-learned diffusion model may include finetuning, by the computing system, the machine-learned diffusion model using the one or more finetuning tuples. The machine-learned diffusion model may include a text-to-image diffusion model and one or more super-resolution diffusion models that sequentially follow the text-to-image diffusion model, and where the text-to-image diffusion model and at least one of the one or more super-resolution diffusion models have been finetuned using the one or more finetuning tuples. Processing, by the computing system, the finetuning prompt and the edit prompt with the machine-learned diffusion model may include performing, by the computing system, classifier-free guidance to adjust the machine-learned diffusion model toward the edit prompt and away from an unconditioned setting. Processing, by the computing system, the finetuning prompt and the edit prompt with the machine-learned diffusion model may include performing, by the computing system, prompt guidance to adjust the machine-learned diffusion model toward the edit prompt and away from a base prompt. Processing, by the computing system, the finetuning prompt and the edit prompt with the machine-learned diffusion model may include processing, by the computing system, the finetuning prompt and the edit prompt and a set of noise with the machine-learned diffusion model to generate the output image. Processing, by the computing system, the finetuning prompt and the edit prompt with the machine-learned diffusion model may include processing, by the computing system, the finetuning prompt and the edit prompt and a noised image generated from the base image with the machine-learned diffusion model to generate the output image. The computer-implemented method described above may include interpolating, by the computing system, the base image and the output image to generate a second output image. The output image may depict the desired edit performed to the base image. Implementations of the described techniques may include hardware, a method or process, or computer software on a computer-accessible medium.

Another general aspect includes a computer-implemented method to train a diffusion model to perform text-driven image editing. The computer-implemented method includes obtaining, by a computing system may include one or more computing devices, a base image and an edit prompt, where the edit prompt may include or is derived from a natural language description of a desired edit to the base image. The method also includes accessing, by the computing system, a machine-learned diffusion model. The method also includes finetuning, by the computing system, the machine-learned diffusion model on one or more finetuning tuples, each finetuning tuple may include the base image and a finetuning prompt. Other embodiments of this aspect include corresponding computer systems, apparatus, and computer programs recorded on one or more computer storage devices, each configured to perform the actions of the methods.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIGS. 1A-C show an example process for text-driven image editing via image-specific finetuning of diffusion models. Specifically, FIG. 1A depicts a block diagram of an example approach to train a diffusion model to perform text-conditioned image generation according to example embodiments of the present disclosure. FIG. 1B depicts a block diagram of an example approach to finetune a diffusion model on a specific base image according to example embodiments of the present disclosure. FIG. 1C depicts a block diagram of an example approach to generate an output image that depicts a desired edit to the base image according to example embodiments of the present disclosure.

FIGS. 2A-C depict example computing systems and devices. Specifically, FIG. 2A depicts a block diagram of an example computing system according to example embodiments of the present disclosure. FIG. 2B depicts a block diagram of an example computing device according to example embodiments of the present disclosure. FIG. 2C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to systems and methods for general text-driven image editing, example implementations of which may be referred to as “UniTune”. Example implementations of the present disclosure can receive as input an arbitrary image and a textual edit description, and can carry out the edit while maintaining high semantic and visual fidelity to the input image. Example implementations of the present disclosure do not require any additional inputs, like masks or sketches. According to an aspect of the present disclosure, with the right choice of parameters, example systems described herein can fine-tune a large diffusion model (e.g., Imagen) on a single image, encouraging the model to maintain fidelity to the input image, both visually and semantically, while still allowing expressive manipulations. The proposed approach was tested in a range of different use cases and experimental results demonstrate its wide applicability.

One example aspect of the present disclosure pertains to a computer-implemented method to perform text-driven image editing using a machine-learned diffusion model. This technology can be used to edit a base image according to a natural language description provided in an edit prompt. For example, the edit prompt could instruct the model to change the color of an object in the image, add a new element, alter the image's lighting, and/or perform other edits to the image. The model can then generate an output image that incorporates these edits while maintaining the overall fidelity of the base image.

The diffusion model used in the present disclosure can be fine-tuned on one or more finetuning tuples. Each of these tuples can include the base image and a finetuning prompt. The fine-tuning prompt can include or be derived from one or more rare tokens, which help the model to focus on the specific features of the base image that need to be preserved.

Another aspect of the present disclosure relates to the use of a combined prompt during the image editing process. This combined prompt can be created by concatenating the finetuning prompt with the edit prompt. This approach ensures that the model takes into account both the original features of the base image and the desired edits when generating the output image. For instance, if the base image is a beach scene and the edit prompt asks for a sunset, the combined prompt would guide the model to maintain the beach elements while adding a sunset to the scene.

In some implementations, the machine-learned diffusion model can include a text-to-image diffusion model and one or more super-resolution diffusion models. The text-to-image model can be responsible for generating a low-resolution version of the output image, while the super-resolution models refine this image to produce a high-resolution result. Both the text-to-image model and at least one of the super-resolution models can be fine-tuned using the finetuning tuples. This multi-stage approach allows the technology to generate high-quality edited images even when the edit prompt involves complex or detailed changes.

Some example methods described in the present disclosure also involve the use of classifier-free guidance. This technique adjusts the diffusion model towards the edit prompt and away from an unconditioned setting, ensuring that the model's output aligns closely with the desired edits. For example, if the edit prompt asks for a sunset to be added to a beach scene, the classifier-free guidance would guide the model to add the sunset while preserving the rest of the beach elements.

Prompt guidance is another technique used in the present disclosure. Prompt guidance can adjust the diffusion model towards the edit prompt and away from a base prompt. This allows the model to focus on the desired edits without being overly influenced by the base image's original features. For example, if the base image is a daytime beach scene and the edit prompt asks for a sunset, the prompt guidance would help the model to add the sunset without overly preserving the daytime lighting.

Some example implementations of the present disclosure also incorporate a set of noise into the image editing process. This noise can be processed with the finetuning prompt and the edit prompt by the diffusion model to generate the output image. The inclusion of noise in the process can help to create a more natural and realistic-looking edited image. For instance, the noise could introduce slight variations in color or texture that make the edited elements blend more seamlessly with the rest of the image, or may otherwise serve as a random place to initialize the model.

In some implementations, the method involves processing a noised image generated from the base image with the diffusion model to create the output image. This approach can increase the visual fidelity of the output image, as it starts with a version of the base image that already incorporates some level of noise. For example, if the base image is a beach scene and the edit prompt asks for a sunset, the noised image might include a slightly altered version of the beach scene that makes the addition of the sunset look more natural.

Some example methods provided herein also include interpolating the base image and the output image to generate a second output image. This interpolation process can further enhance the visual fidelity of the edited image, as it ensures that the final result maintains some of the base image's original features. For example, if the base image is a beach scene and the output image includes a newly added sunset, the interpolation would blend these two images to create a final result that looks like a natural beach scene at sunset.

The present disclosure provides a new and efficient method of text-driven image editing using a machine-learned diffusion model. This technology can significantly enhance the performance of computing systems in several ways. For instance, the use of a fine-tuned diffusion model can result in faster and more accurate image editing tasks. The machine-learned diffusion model can quickly process the edit prompt to generate an output image, thus saving significant computation time and resources.

Moreover, the present disclosure can increase the energy efficiency of computing systems. The method uses a fine-tuned diffusion model that requires less energy to maintain in memory and perform calculations within the model. This results in less energy being expended to perform a given task, such as maintaining the model in memory or performing calculations within the model. This increased energy efficiency can also allow for more tasks to be completed within a given energy budget. For instance, a larger quantity of tasks, more complex tasks, or the same task but with more accuracy or precision can be completed.

The present disclosure not only enhances the performance and energy efficiency of computing systems but also enables new functionalities. For instance, the method allows for fine-tuning of the diffusion model using rare tokens. This unique feature allows the model to focus on specific features of the base image that need to be preserved during the editing process.

Thus, the present disclosure provides systems and methods, example implementations of which may be referred to as “UniTune”, which represent meaningful steps toward the goal of general domain high-fidelity image editing. Specifically, the present disclosure provides a novel method to edit images by simply supplying a textual description of the desired result, without requiring masks. Moreover, example implementations of the present disclosure preserve high fidelity to the entirety of the input image, including the edited portions. Fidelity can be preserved both to visual details (e.g. shapes, colors, and textures) and to semantic details (e.g. objects, poses, and actions).

Furthermore, some example implementations of the present disclosure are able to edit arbitrary images in complex cross domain scenes. Example implementations demonstrated the ability to perform both localized edits as well as broad global edits. The proposed technique is unique in its ability to pinpoint complex local edits without edit masks and in its ability to make image-wide stylistic changes that maintain only semantic details.

More particularly, some example implementations of the present disclosure perform expressive image editing by harnessing the power of large scale text-to-image diffusion models. The proposed approaches harness a simple yet powerful technique for transferring the visual and semantic capabilities of such diffusion models to the domain of image editing.

One main observation is that, with the right parameters, fine-tuning large diffusion models on a single (image, prompt) pair does not lead to complete catastrophic forgetting. A fine-tuned model will strongly prefer to associate the provided image and prompt together and will strongly prefer to draw samples that are almost identical to the provided image given other prompts. However, the visual and semantic knowledge that the model acquired in its original training is still usable across a very wide variety of edit operations (e.g., which can be leveraged by performing Classifier Free Guidance). The fidelity-expressiveness balance can be tuned by controlling the number of training steps and learning rate, or the amount of Classifier Free Guidance and SDEdit.

Fine-tuning of diffusion models is a powerful technique, relevant to many use cases, including, for example, image-to-image translation and topic-driven image generation. These approaches attempt to mitigate over-fitting at training time by data augmentation, using large data sets, or limiting fine-tuning to the embedding of specific tokens. This allows these techniques to learn, for example, the essence of a subject, without learning transient image-specific attributes, like pose, camera angle, background, etc. For our use case of image editing, some over-fitting is beneficial as we actually aim to maintain high fidelity to the source image. The present disclosure represents the first method to use fine tuning of a large diffusion model for the use case of image editing.

With reference now to the Figures, example embodiments of the present disclosure will be discussed in further detail.

### Example Text-Driven Image Editing

Some example implementations are configured to convert a text-to-image diffusion model, f_{θ} into a text-conditioned image editor, f_{θ*} for a specific user provided base image, x^{(b)}. The new model should be able to accept edit prompts c, that describe the image after the edit, and output an edited image, x₀ that satisfies the condition c and maintains fidelity to x^{(b)}.

Some example methods are composed of two stages: (1) fine-tune the model on the base image x^{(b)} alone (2) use a modified sampling process that balances fidelity to the base image x^{(b)} and alignment to the edit prompt c.

### Example Fine-Tuning

Some example implementations fine-tune the model on x^{(b)} for a fixed number of steps, encouraging it to produce images that are close to the base image. For example, some example implementations use a text-condition during the fine-tuning stage, c^{(b)}, that is composed of some number (e.g., 3) of rare tokens, creating a rare word which is not found in the original training data of f_{θ}. Some example implementations use the diffusion model denoising loss with fixed condition and image:

$${𝔼}_{ε , t} [ {w}_{t} {‖ {f}_{θ} ( {α}_{t} {x}^{( b )} + {σ}_{t} ε , {c}^{( b )} ) - ε ‖}_{2}^{2} ] \qquad ( 1 )$$

where t˜ [symbol] ([0,1]), ε˜ [symbol] (0, 1) and wₜ, αₜ, σₜ are functions of t determined by the noising schedule of the diffusion model.

### Example Sampling

To perform the edit operation, some example implementations sample the fine-tuned model by concatenating c and c^{(b)} (i.e., the string “[rare_tokens] edit_prompt”). With naive sampling, the fine-tuned model's bias towards x^{(b)} outweighs the provided prompt c and the model produces an image very similar to x^{(b)} Classifier free guidance can be used to guide the model towards the concatenated prompt, producing an image that maintains fidelity to x^{(b)} while satisfying c. Since some example implementations use a high value for the Classifier Free Guidance weight and/or apply Oscillating Guidance and/or Dynamic Thresholding. To increase visual fidelity, some example implementations begin sampling at a lower step t (instead of starting with t=1) and initialize the sampling with an appropriately noised version of x^{(b)} (instead of random Gaussian noise) using the diffusion forward process:

$${z}_{t} = {α}_{t} {x}^{( b )} + {σ}_{t} ε \qquad ( 2 )$$

zₜ is the initialization value, ε˜ [symbol] (0, 1) and αₜ, σₜ are functions of t determined by the noising schedule of the diffusion model. Finally, to further preserve fine details from the source image x^{(b)}, some example implementations linearly interpolate the pixels of the generated image with the pixels of x^{(b)} The interpolation weight can be determined by the similarity of the pixel neighborhoods.

### Example Implementation Details

Some example implementations used Imagen as the text-to-image model, with a frozen T5-XXL encoder for text embedding. Imagen is composed of a text-to-image model that generates 64×64 pixels output, and two super resolutions models that convert the 64×64 image to a 256×256 image and then to a 1024×1024 image. Some example implementations fine-tune the first two models and use the default 1024 model. Some example implementations train the 64×64 model with Adafactor and the 256×256 model with Adamw with a learning rate of 0.0001 (the same setting used when training Imagen). Some example implementations use a batch size of 4 and emit weights at 16, 32, 64, 128 training steps (some example implementations use less training steps when expressiveness is needed, and more when fidelity is needed). In this setting, one example fine-tuned model can reproduce x^{(b)} after 64 iterations.

It was observed that when fine-tuning with a very low number of steps (16-128) and using Classifier Free Guidance, the model takes into account the edit prompt and then returns an image x₀ that is similar to x^{(b)} and satisfies c as desired. Surprisingly, despite the fact that some example implementations used a pixel-level MSE loss at fine-tuning, the similarity of x₀ to x^{(b)} is often semantic and their MSE can be very different, indicating that fine-tuning changed the biases in an internal semantic representation of the model.

Some example implementations demonstrated that when using a fine-tuned model, starting the sampling with very noisy versions of x^{(b)} is enough to maintain high visual fidelity (because the model is already biased towards x^{(b)}). Therefore, to increase visual fidelity some example implementations start the sampling at step 0.8≤t≤0.98 and noise the base image appropriately. Some example implementations also used various values for Classifier Free Guidance, and the value of 32 demonstrated benefits.

### Example Data Flow Visualizations

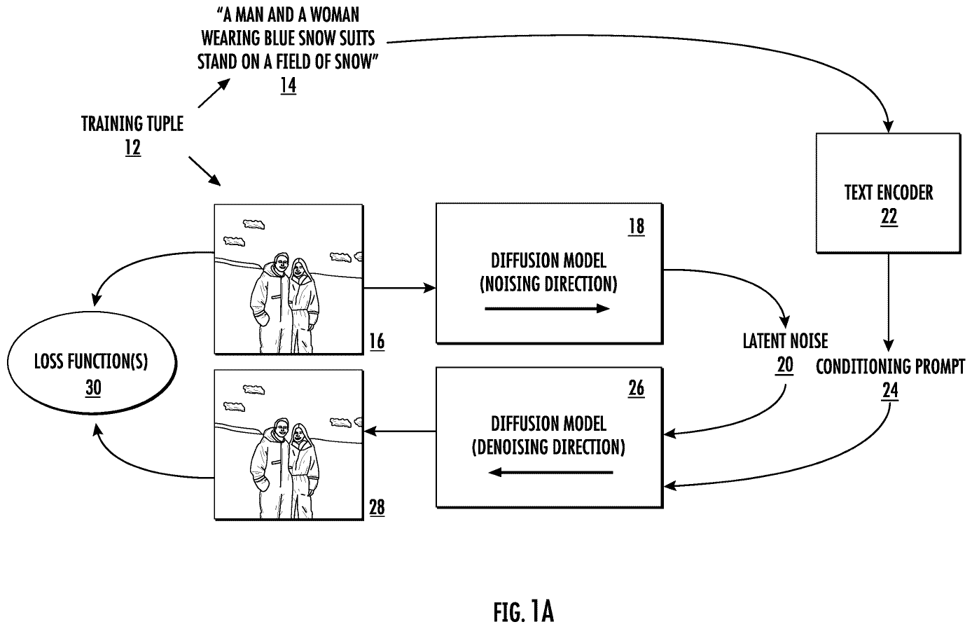

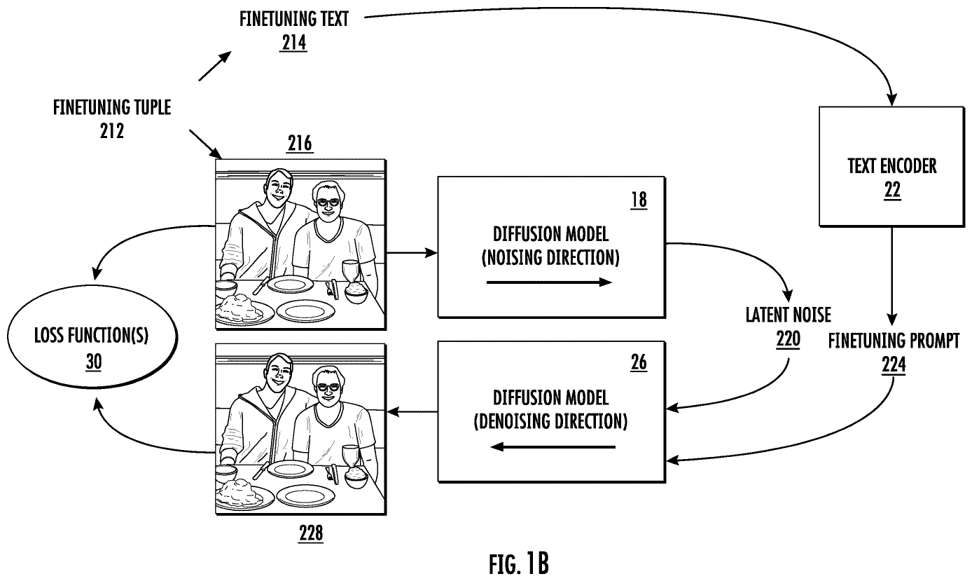

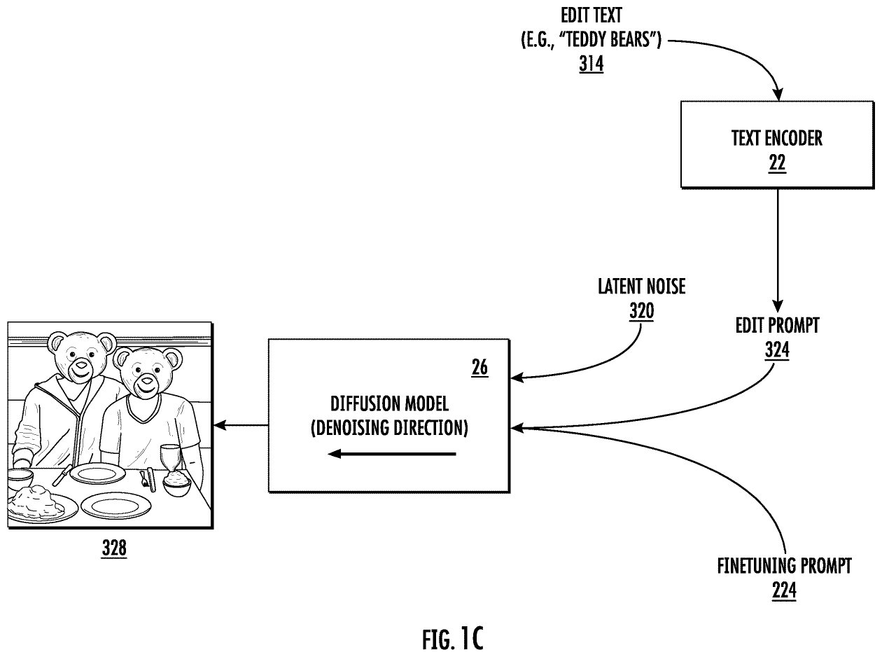

FIGS. 1A-C show an example process for text-driven image editing via image-specific finetuning of diffusion models. Specifically, FIG. 1A depicts a block diagram of an example approach to train a diffusion model to perform text-conditioned image generation according to example embodiments of the present disclosure. FIG. 1B depicts a block diagram of an example approach to finetune a diffusion model on a specific base image according to example embodiments of the present disclosure. FIG. 1C depicts a block diagram of an example approach to generate an output image that depicts a desired edit to the base image according to example embodiments of the present disclosure.

Referring first to FIG. 1A, a training approach can be applied to a large number of training tuples. One example training tuple 12 is shown in FIG. 1A. The training tuple 12 includes a training image 16 and a set of training text 14 that describes the content of the training image 16.

The training image 16 can be processed by a diffusion model 18 in a noising direction to generate a set of latent noise 20. The training text 14 can be processed by a text encoder 22 to generate a conditioning prompt. The text encoder 22 can be a transformer model (e.g., BERT, T5, etc.), the CLIP model, and/or other encoders.

The latent noise 20 and the conditioning prompt 24 can be processed by the diffusion model 26 in a denoising direction to generate a reconstructed image 28. The reconstructed image 28 can be an attempt by the diffusion model 26 to reconstruct the training image 16.

One or more loss functions 30 can be used to evaluate the reconstructed image 28. For example, one loss function 30 may compare the reconstructed image 28 to the training image 16. The diffusion models 26 and 18 can be trained based on the loss function(s) 30. For example, the loss function(s) 30 can be backpropagated through the models 26 and 18.

By performing the training approach shown in FIG. 1A over a large number of training examples, the diffusion model 26 can be trained to generate imagery based on input conditioning prompts generated from text.

Referring now to FIG. 1B, according to an aspect of the present disclosure, the diffusion models 26 and 18 can be finetuned on a specific image to be able to later generate output images that correspond to edited versions of the specific image.

In particular, as shown in FIG. 1B, a finetuning tuple 212 can include a base image 216 and a set of finetuning text 214. In one example, the finetuning text 214 can include a set of one or more rare tokens. One example is the rare token “beikkpic”. In another example, the finetuning text 214 can be a set of base text that describes the content of the base image 216. For example, for the example image 216 shown in FIG. 1B, an example base text may state: “Two men sit in a restaurant booth in front of plates of food. The man in the red hoodie has his arm around the man in the blue striped shirt and glasses.”

The base image 216 can be processed by the diffusion model 18 in the noising direction to generate a set of latent noise 220. The finetuning text 214 can be processed by the text encoder 22 to generate a finetuning prompt 224. The text encoder 22 can be a transformer model (e.g., BERT, T5, etc.), the CLIP model, and/or other encoders.

The latent noise 220 and the finetuning prompt 224 can be processed by the diffusion model 26 in a denoising direction to generate a reconstructed base image 228. The reconstructed base image 228 can be an attempt by the diffusion model 26 to reconstruct the base image 216.

One or more loss functions 30 can be used to evaluate the reconstructed base image 228. For example, one loss function 30 may compare the reconstructed base image 228 to the base image 216. The diffusion models 26 and 18 can be trained based on the loss function(s) 30. For example, the loss function(s) 30 can be backpropagated through the models 26 and 18.

In some implementations, the machine-learned diffusion model 26 can include a text-to-image diffusion model and one or more super-resolution diffusion models that sequentially follow the text-to-image diffusion model. In at least some of such implementations, the text-to-image diffusion model and at least one of the one or more super-resolution diffusion models can be finetuned as illustrated in FIG. 1B.

By performing the finetuning approach shown in FIG. 1B for a number of iterations with respect to the same base image 216 and the same finetuning text 214, the diffusion models 26 and 18 can learn to associate the specific visual and semantic features of the specific base image 216 with the finetuning text 214. Thereafter, by providing the finetuning text 214 in combination with edit text that describes desired edit(s) to the base image 216, the diffusion model 26 can generate an output image that reflects the desired edits, but yet still retains the visual and semantic features of the base image 216.

Specifically, referring now to FIG. 1C, a set of edit text 314 can be received. The edit text 314 can be a natural language description of a desired edit to the base image shown in FIG. 1B. In the example shown in FIG. 1C, the edit text 314 is “Teddy Bears”. The text encoder 22 can process the edit text 314 to generate an edit prompt 324.

The diffusion model 26 in the denoising direction can process the edit prompt 324, the finetuning prompt 224 from FIG. 1B, and a set of latent noise 320 to generate an output image 328. The output image 328 can depict the desired edit performed to the base image 216.

In some implementations, the finetuning prompt 224 and the edit prompt 324 can be concatenated to generate a combined prompt and the diffusion model 26 can process the combined prompt.

In some implementations, the latent noise 320 may be the same as latent noise 220 from FIG. 1B or may be a different set of latent noise. Alternatively, in some implementations, rather than processing the latent noise 220, the diffusion model 26 can process a noised image generated from the base image 216. For example, the noised image can be retrieved from a later layer of the diffusion model 18 in the noising direction.

In some implementations, processing the finetuning prompt 224 and the edit prompt 324 with the diffusion model 26 can include performing classifier-free guidance to adjust the diffusion model toward the edit prompt 324 and away from an unconditioned setting.

In some implementations, processing the finetuning prompt 224 and the edit prompt 324 with the diffusion model 26 can include performing prompt guidance to adjust the diffusion model 26 toward the edit prompt 324 and away from a base prompt descriptive of the base image.

In some implementations, the output image 328 can be interpolated with the base image 226 to generate a second output image that may have improved visual consistency.

### Example Devices and Systems

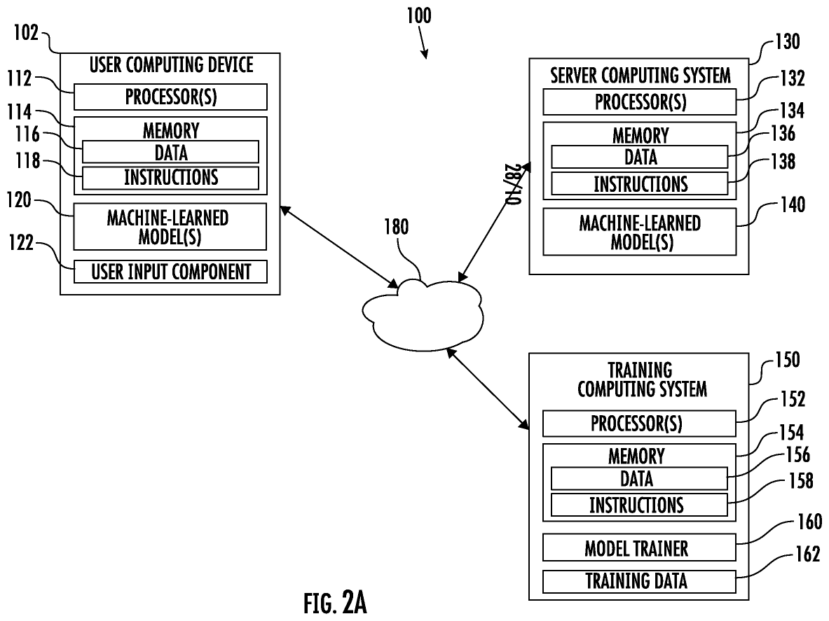

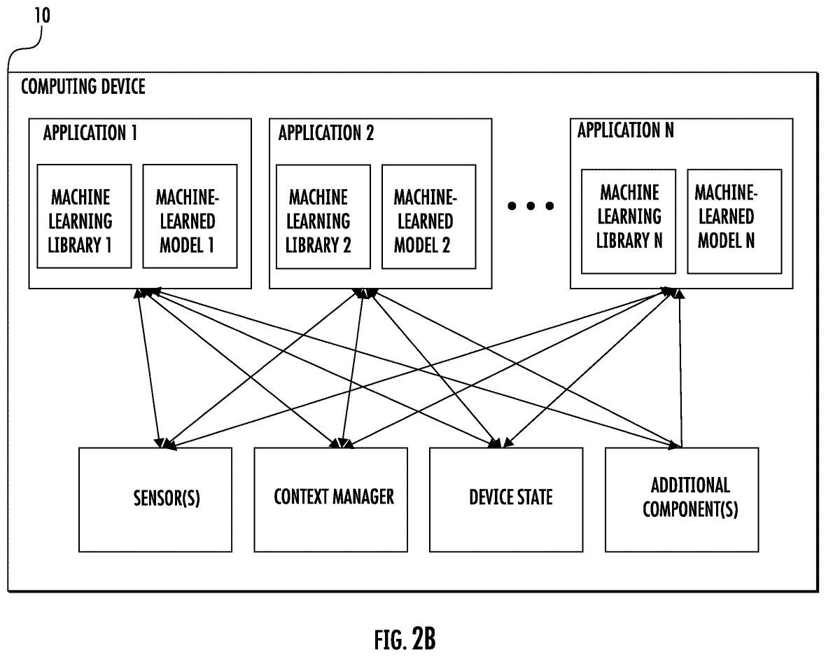

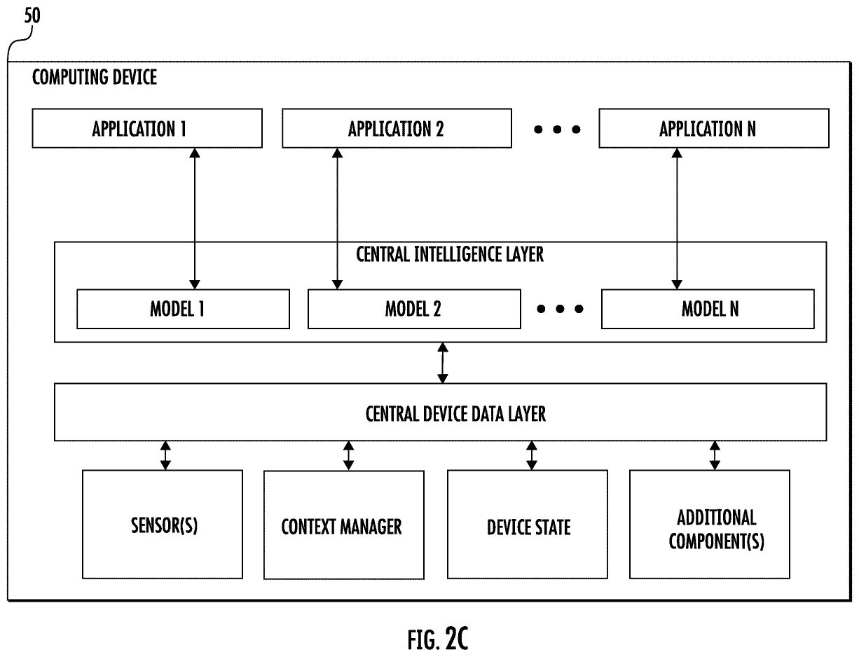

FIG. 2A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1A-C.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel image editing across multiple instances of input images).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an image editing service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM. ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Some example models include diffusion models. Example models 140 are discussed with reference to FIGS. 1A-C.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, pairs of images and text, and a specific base image.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 2A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 2B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to perform text-driven image editing, the method comprising:
obtaining, by a computing system comprising one or more computing devices, a base image and an edit prompt, wherein the edit prompt comprises or is derived from a natural language description of a desired edit to the base image;
accessing, by the computing system, a machine-learned diffusion model, wherein the machine-learned diffusion model has been finetuned on one or more finetuning tuples, each finetuning tuple comprising the base image and a finetuning prompt;
processing, by the computing system, the finetuning prompt and the edit prompt with the machine-learned diffusion model to generate an output image; and
providing, by the computing system, the output image as an output.

2. The computer-implemented method of claim 1, wherein the finetuning prompt comprises or is derived from one or more rare tokens.

3. The computer-implemented method of claim 1, wherein the finetuning prompt comprises or is derived from a base prompt that comprises a natural language description of the base image.

4. The computer-implemented method of claim 1, wherein processing, by the computing system, the finetuning prompt and the edit prompt with the machine-learned diffusion model comprises:
concatenating, by the computing system, the finetuning prompt with the edit prompt to generate a combined prompt; and
processing, by the computing system, the combined prompt with the machine-learned diffusion model.

5. The computer-implemented method of claim 1, further comprising finetuning, by the computing system, the machine-learned diffusion model using the one or more finetuning tuples.

6. The computer-implemented method claim 1, wherein the machine-learned diffusion model comprises a text-to-image diffusion model and one or more super-resolution diffusion models that sequentially follow the text-to-image diffusion model, and wherein the text-to-image diffusion model and at least one of the one or more super-resolution diffusion models have been finetuned using the one or more finetuning tuples.

7. The computer-implemented method of claim 1, wherein processing, by the computing system, the finetuning prompt and the edit prompt with the machine-learned diffusion model comprises performing, by the computing system, classifier-free guidance to adjust the machine-learned diffusion model toward the edit prompt and away from an unconditioned setting.

8. The computer-implemented method of claim 1, wherein processing, by the computing system, the finetuning prompt and the edit prompt with the machine-learned diffusion model comprises performing, by the computing system, prompt guidance to adjust the machine-learned diffusion model toward the edit prompt and away from a base prompt.

9. The computer-implemented method of claim 1, wherein processing, by the computing system, the finetuning prompt and the edit prompt with the machine-learned diffusion model comprises processing, by the computing system, the finetuning prompt and the edit prompt and a set of noise with the machine-learned diffusion model to generate the output image.

10. The computer-implemented method of claim 1, wherein processing, by the computing system, the finetuning prompt and the edit prompt with the machine-learned diffusion model comprises processing, by the computing system, the finetuning prompt and the edit prompt and a noised image generated from the base image with the machine-learned diffusion model to generate the output image.

11. The computer-implemented method of claim 1, further comprising interpolating, by the computing system, the base image and the output image to generate a second output image.

12. The computer-implemented method of claim 1, wherein the output image depicts the desired edit performed to the base image.

13. A computer-implemented method to train a diffusion model to perform text-driven image editing, the method comprising:
obtaining, by a computing system comprising one or more computing devices, a base image and an edit prompt, wherein the edit prompt comprises or is derived from a natural language description of a desired edit to the base image;
accessing, by the computing system, a machine-learned diffusion model; and
finetuning, by the computing system, the machine-learned diffusion model on one or more finetuning tuples, each finetuning tuple comprising the base image and a finetuning prompt.

14. (canceled)

15. (canceled)

16. A computing system, comprising:
one or more processors; and
one or more non-transitory-computer-readable media that collectively store instructions that, when executed by the one or more processors, cause the computing system to perform operations, the operations comprising:
obtaining, by the computing system, a base image and an edit prompt, wherein the edit prompt comprises or is derived from a natural language description of a desired edit to the base image;
accessing, by the computing system, a machine-learned diffusion model, wherein the machine-learned diffusion model has been finetuned on one or more finetuning tuples, each finetuning tuple comprising the base image and a finetuning prompt;
processing, by the computing system, the finetuning prompt and the edit prompt with the machine-learned diffusion model to generate an output image; and
providing, by the computing system, the output image as an output.

17. The computing system of claim 16, wherein the finetuning prompt comprises or is derived from one or more rare tokens.

18. The computing system of claim 16, wherein the finetuning prompt comprises or is derived from a base prompt that comprises a natural language description of the base image.

19. The computing system of claim 16, wherein processing, by the computing system, the finetuning prompt and the edit prompt with the machine-learned diffusion model comprises:
concatenating, by the computing system, the finetuning prompt with the edit prompt to generate a combined prompt; and
processing, by the computing system, the combined prompt with the machine-learned diffusion model.

20. The computing system of claim 16, wherein the operations further comprise finetuning, by the computing system, the machine-learned diffusion model using the one or more finetuning tuples.

21. The computing system of claim 16, wherein the machine-learned diffusion model comprises a text-to-image diffusion model and one or more super-resolution diffusion models that sequentially follow the text-to-image diffusion model, and wherein the text-to-image diffusion model and at least one of the one or more super-resolution diffusion models have been finetuned using the one or more finetuning tuples.

22. The computing system of claim 16, wherein processing, by the computing system, the finetuning prompt and the edit prompt with the machine-learned diffusion model comprises performing, by the computing system, classifier-free guidance to adjust the machine-learned diffusion model toward the edit prompt and away from an unconditioned setting.
